(19) United States
(12) Patent Application Publication
(10) Pub. No.: US 2002/0095868 A1
(43) Pub. Date: Jul. 25, 2002

(54) Mass transit vehicle window installation method and assembly

(76) Inventor: Alvin D. McCauley, Holly, MI (US)

Correspondence Address: REISING ETHINGTON BARNES KISSELLE, LEARMAN AND MCCULLOCH PC, P O BOX 4390, TROY, MI, 48099-4390, US

(21) Appl. No.: 10/027,290

(22) Filed: Dec. 21, 2001

Related U.S. Application Data
(60) Provisional application No. 60/262,931, filed on Jan. 19, 2001.

(51) Int. Cl. E05D 15/06

(52) U.S. Cl. 49/413; 49/414

(57) ABSTRACT

A mass transit vehicle window installation assembly for simplifying and accelerating the installation of window assemblies in vehicle window apertures. The assembly comprises a retainer that connects between a window assembly frame and a vehicle wall panel having a window aperture shaped to receive the window assembly where the window assembly frame has a planform shape that generally complements that of the window aperture. The retainer spaces such a window assembly frame from an inner peripheral surface of a complementary window aperture. The retainer is supported on either a window frame or a complementary window aperture in a position to center the window assembly as the window assembly is inserted into the aperture. This allows an operator to insert a window assembly into a window aperture after one or more of the window assembly retainers have been installed on one of the window frame and window aperture. The retainers cause the window assembly to automatically center itself in a receiving window aperture as an installer inserts the window assembly into the window aperture.

### CROSS REFERENCE TO RELATED APPLICATIONS

This application claims priority from Provisional Application No. 60/262,931, filed Jan. 19, 2001, and entitled “MASS TRANSIT VEHICLE WINDOW INSTALLATION METHOD AND ASSEMBLY,” which is incorporated by reference.

### TECHNICAL FIELD

This invention relates generally to a mass transit vehicle window installation method and assembly for centering and retaining a window assembly in a window aperture formed in a mass transit vehicle wall panel and for simplifying and accelerating the installation of such a window assembly in a mass transit vehicle window aperture.

### BACKGROUND OF THE INVENTION

Methods and assemblies for centering and retaining mass transit vehicle window assemblies in mass transit vehicle window apertures are known in the art. Prior art window aperture constructions include both structural channels, as shown in cross-section in FIGS. 1-3, and tubular members, as shown in cross-section in FIGS. 4 and 5. Both the structural channel and the tubular type are shaped to define the aperture and are fastened into a wall panel structure of a mass transit vehicle.

Structural channel that is used to form window apertures generally comprises extruded aluminum and is available from sources including Alu-Swiss and Robert Wright & Sons. A window aperture defined by structural channel will generally include a recessed detent that extends around an inside perimeter of the aperture as shown in FIGS. 1-3. Tubular members that are used to form window apertures are generally made of steel, aluminum or fiberglass and have generally rectangular box-shaped cross-sections as shown in FIGS. 4 and 5.

Prior art mass transit vehicle window assemblies include windowpanes supported around their outer edges by window assembly frames. The window assembly frame of such an assembly will have a general planform shape that is complementary to but smaller than the shape of the vehicle window aperture that the window assembly is to be installed in.

Prior art window assemblies are known to include window assembly retainers 32 that are connected between the window assembly frames and the window apertures that the frames are installed in. Known window assembly retainers include trim strip rings that approximate the outer planform shape of a window assembly frame and a receiving window aperture. These trim strip rings are installed from the interior of a mass transit vehicle on an interior wall panel of the vehicle after the window assembly frame has already been positioned in the receiving aperture. The trim strip rings are positioned so that they are overlapping both a back surface of the window assembly frame and a back surface of the wall panel immediately adjacent and surrounding the window aperture supporting the window assembly. Trim strip rings are attached to the window assembly frames of window assemblies as well as to the wall panels supporting the frames. Trim strip rings are known to be attached by any one of a number of different methods to include passing fasteners, such as screws, through a trim strip ring, some of which then extend into the back surface of a window assembly frame and others of which extend into an adjacent wall panel back surface.

To properly position a window assembly within a window aperture, installers are known to first position the window assembly within the aperture, and then to insert at least two shims along a bottom or lowermost edge of the window aperture between the aperture and the frame. To achieve proper lateral positioning of the window assembly within the window aperture, installers are known to attempt to visually assess the approximate width of the gaps existing between the window assembly frame and front and rear edge surfaces of the window aperture. If one of the gaps is noticeably wider or narrower than the other, the installer will shift the window assembly either forward or aft as needed to approximately equalize the respective widths of the gaps.

U.S. Pat. No. 4,641,474 to Cannarsa and U.S. Pat. No. 5,193,322 to Wood, while not disclosing window assembly installation methods, each disclose a method and apparatus for installing a panel or insert within another panel or frame member. The Cannarsa patent discloses a method and apparatus for mounting a wallboard insert within a complementary opening in a sheet of wallboard. The Cannarsa method includes mounting wallboard joining clips around an outer edge of the wall board insert before installing the wall board insert in the complementary opening. The Cannarsa clips are configured to engage outer surfaces of the wall board insert and the wall board panel.

The Wood patent discloses a method and apparatus for assembling compound decorative trim molding strips such as crown molding. The disclosed method includes mounting spacer clips along inner edges of a base molding strip then using the clips to install a trim molding insert strip between the inner edges. This spaces the insert strip between the inner edges of the base molding strip.

U.S. Pat. No. 5,021,279 issued to Whitener discloses a trim strip having an elongated stem portion that is inserted into a slot. The stem portion of the trim strip is retained by an interference fit in the slot.

What is needed is a mass transit vehicle window installation method and assembly that allow an installer to both insert and center a mass transit vehicle window in a mass transit vehicle window aperture in a single motion.

### INVENTION SUMMARY

A mass transit vehicle window installation assembly for simplifying and accelerating the installation of window assemblies in vehicle window apertures. The assembly comprises a retainer configured to connect between a window assembly frame and a vehicle wall panel having a window aperture shaped to receive the window assembly, where the window assembly frame has a planform shape that generally complements that of the window aperture. The retainer is additionally configured to space such a window assembly frame from an inner peripheral surface of a complementary window aperture. The retainer is additionally configured to be supported on one of a window frame and a complementary window aperture in a position to center the window assembly as the window assembly is inserted into the aperture. The retainer spaces the window assembly from the window aperture as the installer is inserting the window assembly into the window aperture. This allows a single installer to center a mass transit vehicle window assembly in a mass transit vehicle window aperture simply by inserting the window assembly into the aperture and obviates the need for a separate centering step.

According to another aspect of the invention, the retainer is additionally configured to hold the window assembly frame within the complementary window aperture once the window assembly has been inserted. This aspect of the invention allows an installer to secure the window assembly within the window aperture simply by inserting the window assembly into a complementary-shaped aperture. Additional personnel or implements need not be positioned on an opposite back side of the wall panel to hold the window in place and/or to install a retainer after the window assembly has been inserted.

According to another aspect of the invention, a plurality of the retainers are secured at spaced locations around and between the window assembly frame and the window aperture. This arrangement more securely retains and more effectively centers the window assembly within a window aperture.

According to another aspect of the invention, the window aperture includes a recessed aperture detent that extends around and is formed into an inside peripheral wall of the aperture. In addition, the retainer includes a spring clip fixed to the window assembly frame and configured to snap outward into engagement with the aperture detent to block window assembly movement in a direction opposite a direction of installation.

According to another aspect of the invention, the retainer is fixed to an outer peripheral wall of the window assembly frame.

According to another aspect of the invention, the spring clip includes an elongated resilient spring arm biased outwardly from the outer peripheral wall of the window assembly frame. The spring arm is configured to bend inwardly when contacting a front edge of a window aperture that the window assembly is being inserted into and then to spring back outward when the window assembly is fully inserted. When the window assembly reaches the fully inserted position an outer distal end of the spring arm passes over a recess defining the aperture detent and the distal end of the spring arm engages the aperture detent once the spring arm has sprung back outward.

According to another aspect of the invention, the spring arm comprises an elongated strip of spring steel, plastic or stainless steel.

According to another aspect of the invention, the distal end of the spring arm includes a centering surface configured to engage an inner peripheral surface of a window aperture to space the window assembly frame a predetermined desired distance from an inner peripheral surface of a window aperture that the window assembly is inserted into. The centering surface is also positioned to prevent the spring arm from springing too far outward and allowing the distal end of the spring arm to pass and miss engagement with an aperture detent formed in the inner peripheral wall of the window aperture.

According to another aspect of the invention, the spring arm extends from the window assembly frame in a direction generally opposite the direction of window assembly insertion, and the distal end of the spring arm includes an S-bend forming a detent surface that abuts the aperture detent and an adjacent outer tab. The outer tab, in this case, includes the centering surface for engaging an inner peripheral surface of a window aperture.

According to another aspect of the invention, the spring arm extends from the window assembly frame in the direction of window assembly insertion, and the distal end is configured to hook over a back edge of the window aperture. By hooking over the back edge of the aperture, the distal end of the spring arm secures the window assembly against extraction opposite the direction of window assembly insertion.

According to another aspect of the invention, the retainer includes a spring clip fixed to the window assembly frame. The spring clip includes a spring arm configured to bend inward toward the window assembly frame upon engagement with a front edge of a window aperture that the window assembly is being inserted into. The spring clip is further configured to continuously bias a distal end of the spring arm outward against the inner peripheral surface of the window aperture. The distal end of the spring arm is configured to engage an inner peripheral surface of the window aperture in such a way as to provide an interference fit for the window assembly within the window aperture.

According to another aspect of the invention, the spring arm extends from the window assembly frame in a direction generally opposite the direction of window assembly insertion, and the distal end of the spring arm includes a saw tooth edge. The saw tooth edge is configured and directed in such a way as to dig into an inner peripheral surface of the window aperture to a depth sufficient to secure the window assembly against extraction from the window aperture opposite the direction of window assembly insertion.

According to another aspect of the invention, the retainer includes a trim strip ring that approximates the outer planform shape of the window assembly frame and the window aperture. The trim strip ring is configured to engage respective back surfaces of the window assembly frame and wall panel and to cover a gap formed between a peripheral outer surface of the window assembly frame and a peripheral inner surface of the window aperture when the window assembly frame is installed in a window aperture in the wall panel.

According to another aspect of the invention, the trim ring includes an elongated stem configured to be inserted in the gap. The stem positively positions the trim ring relative to the window assembly frame and the window aperture.

According to another aspect of the invention, the trim ring includes apertures configured to receive fasteners that extend into and engage the window assembly frame to retain the trim ring against the respective inner surfaces of the window assembly frame and wall panel.

According to another aspect of the invention, the trim ring includes an elongated seal ring that prevents moisture and drafts of air from passing through the wall panel through the gap.

According to another aspect of the invention, the window assembly frame includes a front flange that extends outwardly from around a main portion of the frame in a position to be disposed against a front surface of a wall panel that the window assembly is to be installed in. The front flange is configured to cover the gap that remains between the window assembly frame and the inner peripheral wall of a window aperture once the window assembly has been installed in the window aperture. An elongated rubber seal ring is connected around and along a back surface of the front flange in a position to seal against the front surface of the wall panel.

According to another aspect of the invention, the retainer includes a pair of diametrically opposed attachment ears configured to engage respective opposing lateral undercuts formed along opposite sidewalls of a groove formed around the outer peripheral wall of the window assembly frame.

According to another aspect of the invention, the retainer includes a spring clip supported on the window aperture and configured to engage the window assembly frame when the window assembly frame is inserted into the window aperture. The spring clip may be configured to engage opposing channel side walls of a channel formed into and around an inner peripheral wall of the window aperture. The spring clip may include a pair of legs that extend from a base element and are shaped to engage a pair of elongated flanges that extend inwardly from the channel sidewalls. The legs may additionally be constructed to be long enough to prevent the clip from falling into the channel. The clip includes a resilient spring arm that extends diagonally from the base element of the clip such that when the clip is installed properly the spring arm extends diagonally in a direction opposite the direction intended for window assembly frame insertion. The spring arm is configured to bend outwardly toward the inner peripheral wall of the window aperture when contacting a front edge of a window assembly frame of a window assembly that is being inserted into the window aperture. A plurality of the spring clips are spaced around the inner peripheral wall of the window aperture so that their collective inward bias serves to center the window assembly in the window aperture upon insertion.

The invention also includes a method for centering and retaining a window assembly in a window aperture formed in a mass transit vehicle wall panel. According to this method one can center and retain a window assembly in a window aperture formed in a mass transit vehicle wall panel by providing a wall panel including a window aperture and providing a window assembly including a window pane supported around outer edges of the pane by a window assembly frame where the window assembly frame has a general planform shape complementary to and smaller than that of the window aperture. A window assembly retainer is supported on one of the window assembly frame and the window aperture, and the window assembly is then inserted into the window aperture—after having supporting the window assembly retainer on one of the window assembly frame and the window aperture.

According to another aspect of the inventive method, the step of providing a wall panel includes providing a wall panel that includes a window aperture that is at least partially defined by extruded structural channel having a recessed detent formed into an inner peripheral surface of the window aperture. In addition, the step of supporting a window assembly retainer includes providing a window assembly retainer that includes a spring clip fixed to the window assembly frame. The step of inserting the window assembly includes inserting the window assembly such that the spring clip is compressed inward toward the window assembly frame. The window assembly inserting step also includes inserting the window assembly until the spring clip snaps outward into engagement with the aperture detent while remaining engaged against an inner peripheral surface of the window aperture.

According to another aspect of the inventive method, the step of providing a wall panel includes providing a wall panel that includes a window aperture at least partially defined by a tubular structural member. In this case, the step of supporting a window assembly retainer includes the additional step of providing a window assembly retainer that includes a spring clip fixed to the window assembly frame. In addition, the step of inserting the window assembly includes inserting the window assembly such that the spring clip bends inward upon engagement with an outer edge of the window aperture as the window assembly is inserted into the window aperture and the spring clip continuously biases a distal end of the spring clip outward against the inner peripheral surface of the window aperture such that the distal end of the spring clip engages and provides an interference fit for the window assembly within the window aperture.

According to another aspect of the inventive method, the step of supporting a window assembly retainer on one of the window assembly frame and the window aperture includes supporting a plurality of window assembly retainers at spaced locations around one of the window assembly frame and the window aperture.

According to another aspect of the inventive method, the step of supporting a window assembly retainer includes providing a retainer that includes a spring clip comprising a pair of diametrically opposed attachment ears. The ears are inserted into a groove formed around one of the outer peripheral wall of the window assembly frame and the inner peripheral wall of the window aperture. The ears are then engaged in respective opposing lateral undercuts formed along opposite sidewalls of the groove by rotating the spring clip.

According to another aspect of the inventive method, the step of supporting a window assembly retainer includes providing a retainer that includes a spring clip comprising a pair of legs shaped to engage and retain the clip between opposing flanges that extend inwardly from side walls of a channel formed into and around the inner peripheral wall of the window aperture. The legs are then inserted into a channel formed around the inner peripheral wall of the window aperture until the legs engage the flanges.

According to another aspect of the inventive method, the step of inserting the window assembly into the window aperture includes the additional step of inserting the window assembly from a position outside a vehicle that includes the wall panel such that a front flange of the window assembly frame rests against a front surface of the wall panel on an exterior of the vehicle with the window assembly in an installed position. A trim ring may then be installed over a gap formed between a back edge of the window assembly frame and a back edge of the window aperture on the vehicle interior. The trim ring may be installed by snapping it into place and/or by passing fasteners through apertures in the trim strip ring and into an existing groove that runs around the back surface of the window assembly frame.

According to another aspect of the inventive method, the step of inserting the window assembly into the window aperture includes inserting the window assembly from a position inside a vehicle that includes the wall panel. The window assembly is installed such that, with the window assembly in the installed position, a front flange of the window assembly frame rests against a back surface of the wall panel on the vehicle interior. A trim ring may then installed over a gap formed between a back edge of the window assembly frame and a front edge of the window aperture on the vehicle exterior. The trim ring may be installed by snapping it into place and/or by passing fasteners through apertures in the trim strip ring and into an existing groove that runs around the back surface of the window assembly frame.

### BRIEF DESCRIPTION OF THE DRAWINGS

These and other features and advantages of the invention will become apparent to those skilled in the art in connection with the following detailed description and drawings, in which:

FIG. 1 is an end view of a window assembly retainer constructed according to a first embodiment of the invention and shown holding a transom window assembly within a transom window aperture defined by a member of the structural channel type and with seals removed for clarity;

FIG. 2 is an end view of a window assembly retainer constructed according to a first embodiment of the invention and shown holding a fixed or standard window assembly within a window aperture defined by a member of the structural channel type and with seals removed for clarity;

FIG. 3 is an end view of a window assembly retainer constructed according to a first embodiment of the invention and shown holding a sliding window assembly within a window aperture defined by a member of the structural channel type;

FIG. 4 is an end view of a window assembly retainer constructed according to a second embodiment of the invention and shown holding a transom window assembly within a window aperture defined by a member of the tubular type and with seals removed for clarity;

FIG. 5 is an end view of a window assembly retainer constructed according to a third embodiment of the invention and shown holding a window assembly within a window aperture defined by a member of the tubular type and with seals removed for clarity;

FIG. 6 is an end view of a window assembly retainer constructed according to a fourth embodiment of the invention and shown holding a window assembly within a window aperture defined by a member of the structural channel type;

FIG. 7 is a front view of the window assembly retainer of FIG. 6 and shown during installation in a window assembly frame and before being rotated into engagement;

FIG. 8 is an end view of a window assembly retainer constructed according to a fifth embodiment of the invention and shown installed in a window aperture defined by a member of the structural channel type;

FIG. 9 is a front view of the window assembly retainer of FIG. 8;

FIGS. 10-13 are end views of the window assembly retainer of FIG. 1 shown in various stages of transom window assembly insertion and with seals removed for clarity;

FIG. 14 is a schematic diagram of a window assembly showing typical clip locations;

FIG. 15 is a top view of the clip portion of the window assemblies of FIGS. 1, 2 and 3;

FIG. 16 is a front view of the clip of FIG. 16;

FIGS. 17-21 are end views of the window assembly retainer of FIG. 2 shown in various stages of fixed (standard) window assembly insertion and with seals removed for clarity;

FIGS. 22-26 are end views of the window assembly retainer of FIG. 3 shown in various stages of sliding window assembly insertion and with seals removed for clarity;

FIG. 27 is an end view of the window assembly retainer clip of FIG. 5;

FIG. 28 is a top view of the window assembly retainer clip of FIG. 5;

FIG. 29 is a bottom view of the window assembly retainer clip of FIG. 5;

and

FIGS. 30-33 are end views of the window assembly retainer of FIG. 5 shown in various stages of window assembly insertion and with seals removed for clarity.

### DETAILED DESCRIPTION OF A PREFERRED EMBODIMENT

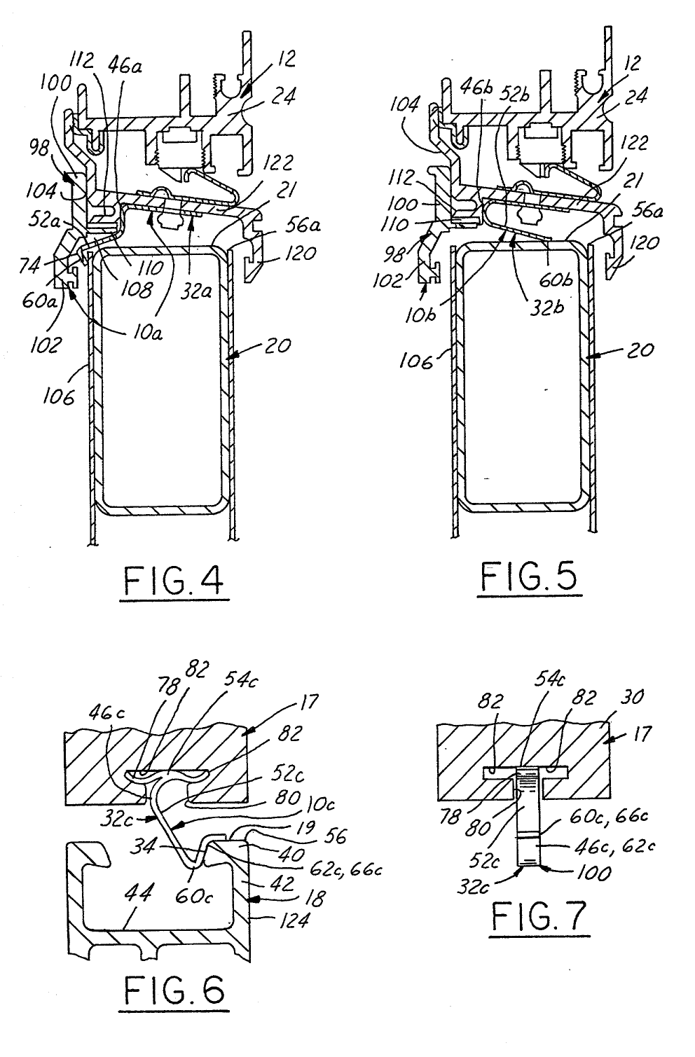

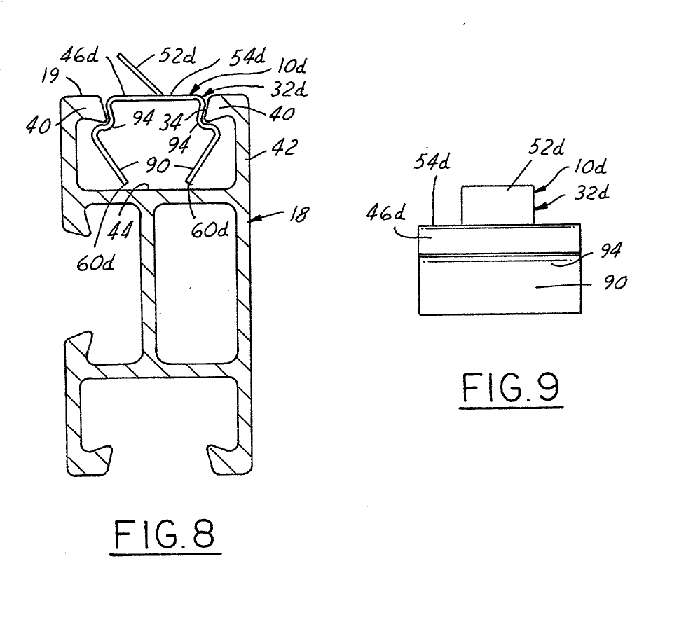

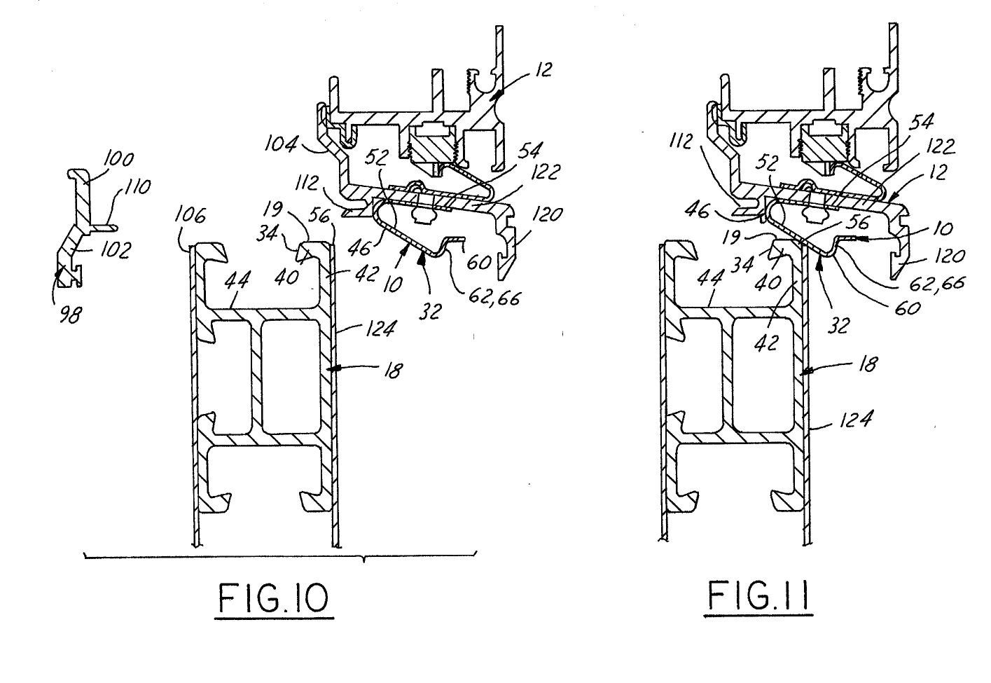

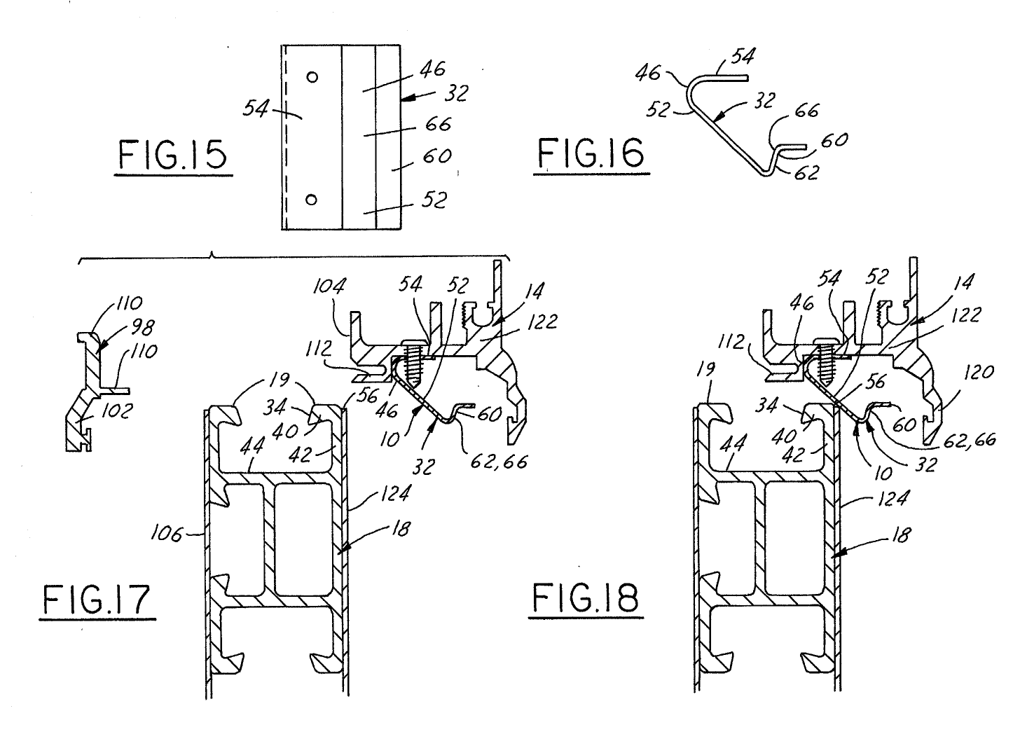

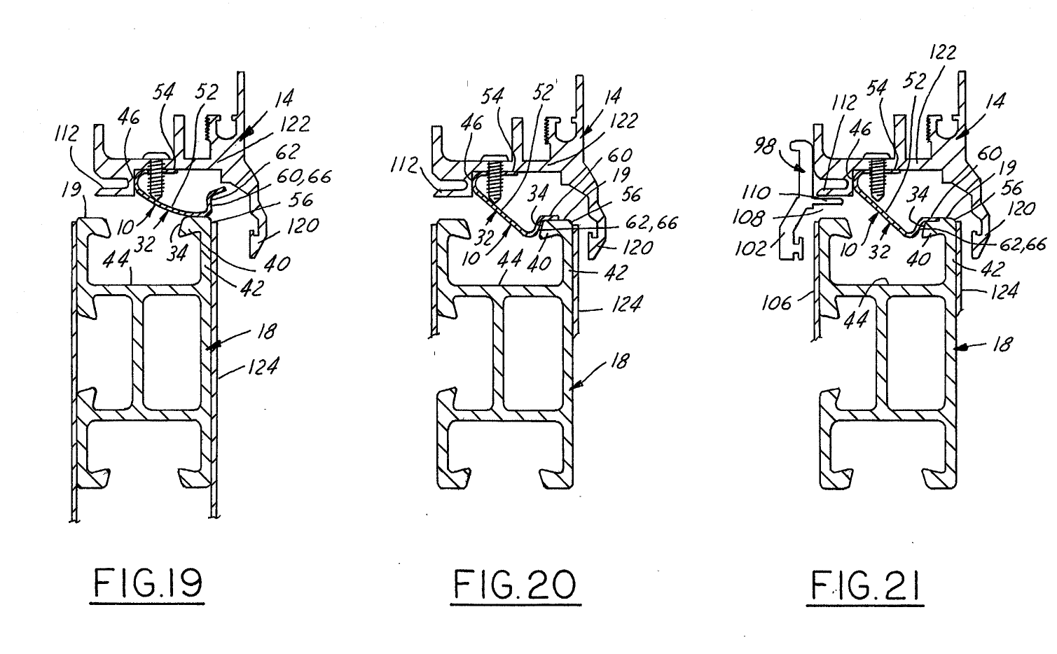

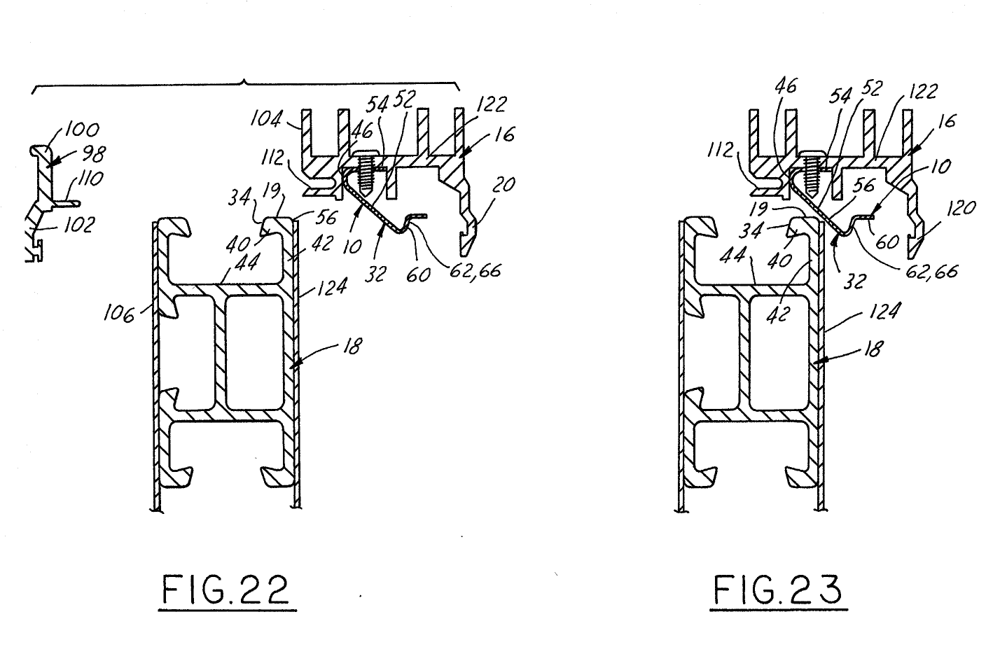

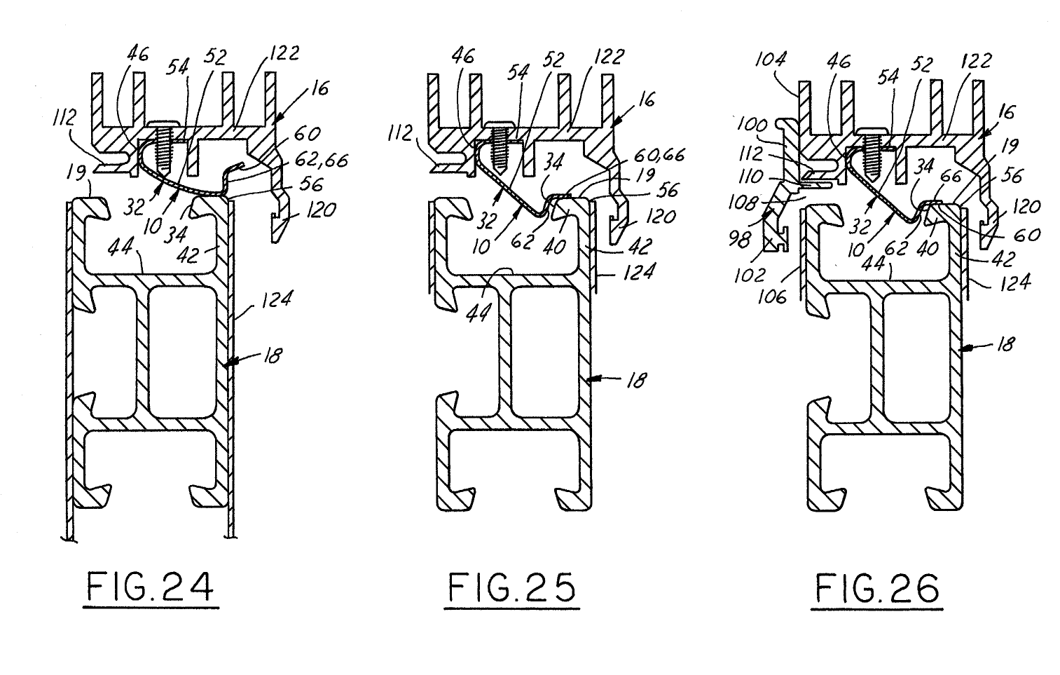

A first embodiment of a mass transit vehicle window installation assembly constructed according to the invention is shown at 10 in FIGS. 1-3, and 17-26. A second embodiment of the invention is shown at 10a in FIG. 4. A third embodiment of the invention is shown at 10b in FIG. 5. A fourth embodiment of the invention is generally indicated at 10c in FIGS. 6 and 7. A fifth embodiment of the invention is generally indicated at 10d in FIGS. 8 and 9. Reference numerals with the suffix “a” in FIG. 4, the suffix “b” in FIG. 5, the suffix “c” in FIGS. 6 and 7, and the suffix “d” in FIGS. 8 and 9, designate the alternative configuration of each element common to the embodiment of FIGS. 1-3. Unless the description indicates otherwise, where the description uses a reference numeral to refer to an element in FIGS. 1-3, that portion of the description applies equally to elements in FIGS. 4-9 indicated by the same reference numeral with the suffix “a”, “b”, “c”, or “d”, respectively.

Each of the window installation assembly embodiments 10, 10a, 10b, 10c, 10d is configured to center and retain a window assembly 12, 14, 16 in a window aperture 18, 20 formed in a mass transit vehicle wall panel 22. In the Figures, the various window installation assembly embodiments are shown supported on or engaging four different representative types of window assemblies shown at 12, 14, 16 and 17, respectively. Each of the four window assemblies 12, 14, 16, 17 includes a window assembly frame 24, 26, 28, 30 configured to hold a transparent windowpane as shown at 15 in FIG. 1.

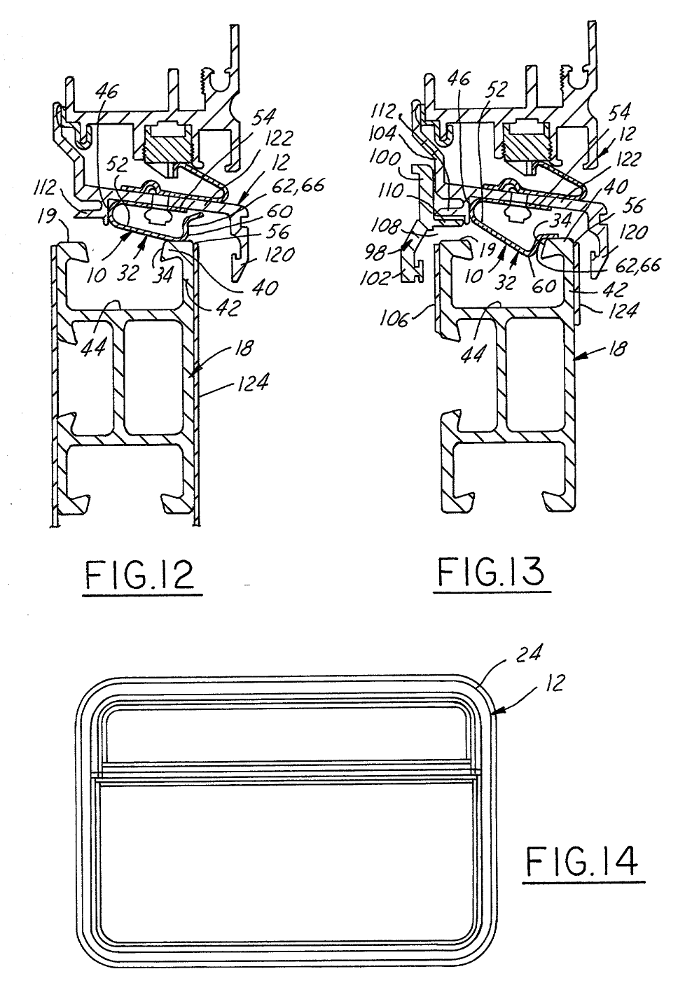

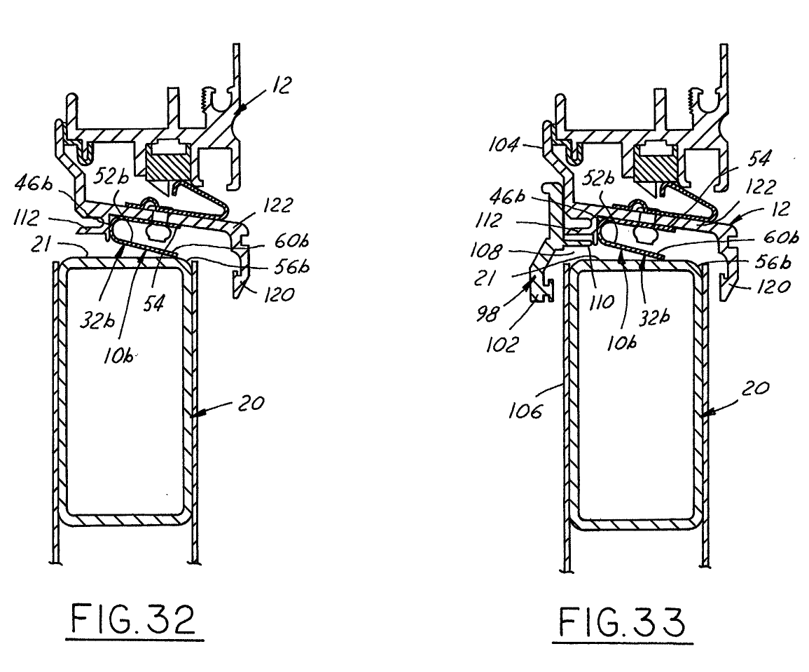

The various installation assembly embodiments are also shown engaging or supported on two different representative type window apertures. One of the aperture types, constructed from structural channels, is shown at 18 in FIGS. 1-3, 6, 8, 10-13, and 17-26. A second aperture type, constructed from tubular members, is shown at in FIGS. 4, 5 and 30-33.

The window assembly frame 24, 26, 28, 30 of each window assembly 12, 14, 16, 17 has a planform shape complementary to that of a corresponding mass transit vehicle wall panel window aperture 18, 20 that the window assembly frame 24, 26, 28, 30 is intended to be mounted in. The planform shape of such a frame 24 is best shown in FIG. 14.

The first embodiment of the window installation assembly 10 includes a plurality of window assembly retainers 32 that connect between the window assembly frame 24, 26, 28 of a window assembly 12, 14, 16 and a window aperture 18 that the window assembly 12, 14, 16 is installed in. The arrows in FIG. 14 show typical locations for the retainers 32. From these peripheral locations, the window assembly retainers 32 are able to center the window assembly 12, 14, 16 in a transit vehicle window aperture 18. They do so by spacing the window assembly frame 24, 26, 28 a predetermined desired distance from around an inner peripheral wall 19 of such a window aperture 18. The use of these retainers 32 allows an operator to insert a window assembly 12, 14, 16 into a complementary window aperture 18 with the window assembly retainers 32 having been previously fastened to a window assembly frame 24, 26, 28. In other embodiments, the retainers 32 may instead be supported on a vehicle window aperture 18. In still other embodiments some retainers 32 may be supported on a window assembly frame 24, 26, 28 and other retainers 32 may be mounted on a receiving window aperture 18. In each case, however, the retainers 32 will center a window assembly 12, 14, 16 automatically when an installer inserts the window assembly into a vehicle window aperture 18.

In yet other embodiments the number of retainers 32 for each window assembly 12, 14, 16 may vary and the retainers 32 may be either longer or shorter in length than as shown in the Figures. In fact, there may, for each window assembly 12, 14, 16, be only a single retainer comprising a single elongated strip that is shaped to extend around either an entire outer periphery of a window assembly frame 24, 26, 28 of each window assembly 12, 14, 16 or an entire inner periphery of a corresponding window aperture 18.

The retainers 32 are shaped and positioned so that only a single inserting motion is required to retain window assembly frames 24, 26, 28 within complementary window apertures 18. No additional fasteners or other fastening hardware are required. This allows a single installer to secure a window assembly 12, 14, 16 within a complementary window aperture 18 by simply lifting and inserting a window assembly 12, 14, 16 into a complementary window aperture 18 in a mass transit vehicle wall panel 22. No additional personnel or implements are required to assist in the installation process because there is no need for a person to hold a window assembly in place from the inside of a vehicle while another person installs a retainer from the outside; or, for a person to hold a window assembly in place from the outside of a vehicle while another person installs a retainer from the inside.

The retainers 32 of the first embodiment are designed to engage a window aperture 18 that includes a recessed aperture detent 34 that extends around and is formed into the inner peripheral wall 19 of the window aperture. The detent 34 is preferably disposed on an axially inward facing surface of an elongated flange 40 that extends axially inwardly from an inner sidewall 42 of a channel 44 formed into and around the inner peripheral wall 19 of the aperture 18.

The retainers 32 each include a spring clip 46 designed to mount on an outer peripheral wall of a window assembly frame 24, 26, 28. So mounted, the spring clip 46 of each retainer 32 will engage the inner peripheral wall 19 of a window aperture 18 as the window assembly frame is inserted into it. When the spring clips 46 engage the aperture detent, 34 they block window assembly movement in a direction opposite a direction of window assembly insertion.

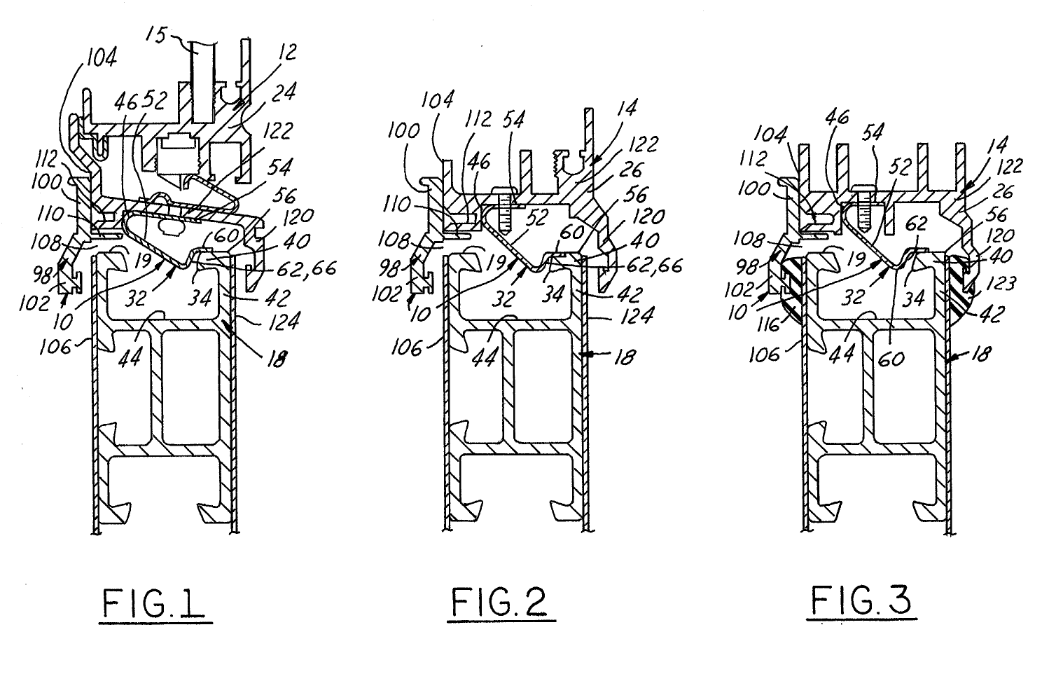

Each spring clip 46 includes an elongated resilient spring arm 52 comprising an elongated strip of spring steel. In other embodiments, the spring arms 52 may be made of any other suitable material to include plastic or stainless steel. Each spring arm 52 is biased outwardly from a mounting base 54 of the spring clip 46 that attaches to the outer peripheral wall of the window assembly frame 24, 26, 28. As shown in FIGS. 2 and 3, the length of the base 54 of the spring clip 46 may vary depending on the configuration of the window assembly frame 24, 26, 28 it is to be mounted on.

Each spring arm 52 extends from its associated mounting base 54 in a direction that, when the clip 46 is attached to the outer peripheral wall of a window assembly frame 24, 26, 28, is generally opposite the direction of window assembly insertion. This causes the spring arm 52 to bend inwardly when contacting a front edge 56 of a window aperture 18 during window assembly insertion, and then to spring back outward when the window assembly 12, 14, 16 is fully inserted. When the window assembly 12, 14, 16 reaches the point where it is fully inserted into a window aperture 18, an outer distal end 60 of the spring arm 52 passes over a recess or channel 44 that defines the aperture detent 34. When the outer distal end 60 of the spring arm 52 passes over the recess 44, the spring arm 52 is free to spring back outward into the recess 44. This moves the distal end 60 of the spring arm 52 to a position where it engages the aperture detent 34.

The distal end 60 of each spring arm 52 includes a centering surface 62 that is shaped and positioned to engage the inner peripheral surface 19 of a window aperture 18. The centering surface 62 engages the inner peripheral surface 19 of a window aperture 18 in such a way as to cause the spring arm 52 to space the window assembly frame 24, 26, 28 a predetermined desired distance from the inner peripheral surface 19 of the window aperture 18 that the frame is mounted in. The centering surfaces 62 of the spring arms 52 also prevent the spring arms 52 from springing too far outward and causing the distal ends 60 of the spring arms 52 to move past and miss engagement with their corresponding aperture detents 34.

As shown, for example, in FIGS. 1-3, the distal end 60 of each spring arm 52 includes an S-bend 66 that forms the detent surface that abuts the aperture detent 34. The S-bend 66 also forms an adjacent outer tab 68 that includes the centering surface 62 for engaging the inner peripheral surface 19 of a window aperture 18.

The second embodiment of the invention, as shown in FIG. 4, comprises a retainer spring clip 46a includes a spring arm 52a that extends from a mounting base 54a of the retainer spring clip 46a in a direction that, when the retainer spring clip 46a is attached to an outer peripheral wall of a window assembly frame 24, is generally the same as the direction of window assembly insertion, rather than extending opposite the direction of insertion. According to this embodiment, a distal end 60a of each spring arm 52a includes a downward curved portion 74 shaped and positioned to hook over a back edge 76 of the receiving window aperture 20. By forming the distal end 60a of each spring arm 52a to hook over the back edge 76 of an aperture 20, the distal ends 60a of the spring clips 46a are able to secure the window assembly 12 against extraction from the aperture 20 opposite the direction of window assembly insertion.

The third embodiment of the invention, as shown in FIG. 5, comprises a spring clip 46b including spring arms 52b having distal ends 60b shaped and positioned to engage the inner peripheral surface 21 of a window aperture 20 in such a way as to provide an interference fit for a window assembly within the window aperture 20. To maintain the interference fit, the spring clips 46b are shaped and positioned to continuously bias the distal ends 60b of the spring arms 52b outward against the inner peripheral surface 21 of such a window aperture 20.

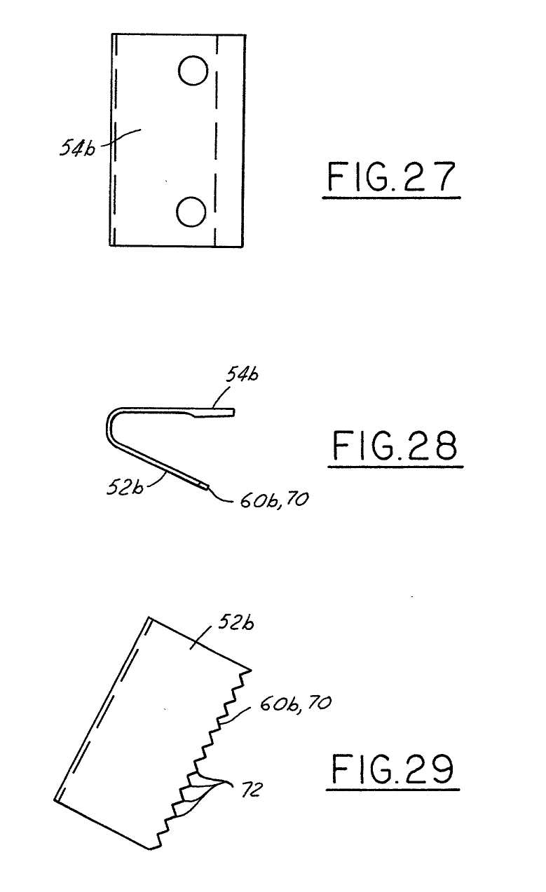

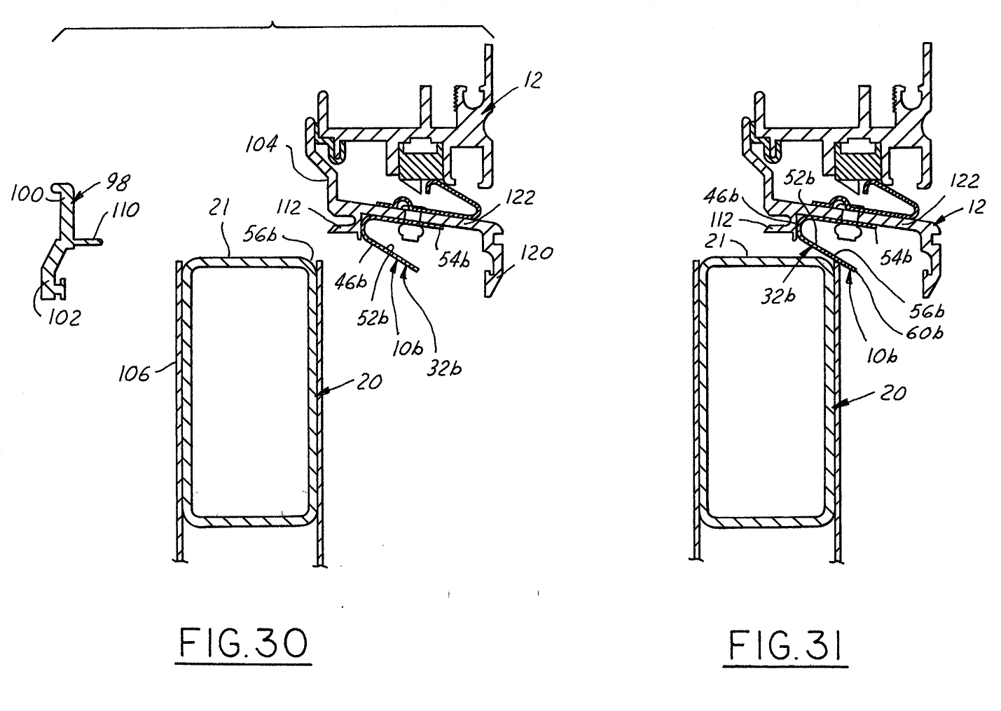

As with the embodiments of FIGS. 1-3, the spring arms 52b of spring clips 46b constructed according to this embodiment are intended to extend from a window assembly frame 24 in a direction generally opposite the direction of window assembly insertion. However, unlike the embodiments of FIGS. 1-3, and as is best shown in FIGS. 27-29, the distal end 60b of each spring arm 52b includes a saw tooth edge 70. The saw tooth edges 70 dig into the inner peripheral surface 21 of a corresponding window aperture 20 when the window assembly frame 24 is inserted into the aperture 20. The saw tooth edge 70 and spring arms 52b are designed to drive individual teeth 72 of the saw tooth edge 70 a sufficient depth into the inner peripheral surface 21 of a window aperture 20 to secure the window assembly against extraction from the window aperture 20 opposite the direction of window assembly insertion. The degree to which the saw tooth edge 70 and the spring arms 52b are designed to dig into the inner peripheral window aperture surface 21 of a window aperture 20 depends on the application. Stiffer spring arms 52b and sharper saw teeth 72 may be used in applications where they are the primary or only means of holding a window assembly frame 24 in a window aperture 20. Where, on the other hand, they are only intended to hold a window assembly frame 24 in place long enough for other retaining means to be installed, softer spring arms 52b and duller saw teeth may be used. Softer spring arms 52b will, of course, require less effort to install. In other embodiments, suitable edge configurations other than saw tooth configurations may be used.

The fourth embodiment of the invention, as shown in FIGS. 6 and 7, comprises a retainer spring clip 46c including a mounting base 54c having a pair of radially extending, diametrically opposed attachment ears 78. The ears 78 are positioned and shaped to be inserted into an inserted position within a groove 80 formed around the outer peripheral wall of a window assembly frame 30. The ears 78 are also shaped and positioned to be moved to an engaged position engaging respective opposing lateral undercuts 82 disposed in and along opposite sidewalls of the groove 80. The ears 78 are moved from the inserted position to the engaged position by rotating the spring clip 46 approximately ninety degrees. The ears 78 are shown inserted but disengaged in FIG. 7 and in the engaged position in FIG. 6.

The fifth embodiment of the invention, as shown in FIGS. 8 and 9, comprises a spring clip 46d that is designed to be supported on a window aperture 18 rather than a window assembly frame. The spring clip 46d is configured to engage a window assembly frame when such a frame is inserted into a window aperture 18 that one or more of the spring clips 46d are mounted on. The spring clip 46d engages opposing channel side walls 42 of a channel 44 formed into and around an inner peripheral wall 19 of the window aperture 18. The spring clip 46d is approximately 1 to 3 inches in length and includes a pair of legs 90 that extend from a mounting base 54d and are shaped to engage a pair of elongated flanges 40 that extend inwardly from the channel sidewalls 42. The legs 90 engage the flanges 40 when the clip 46d is pushed, legs first, into the channel 44. The legs 90 have S-shaped bends 94 that allow the legs 90 to easily bend inward as the clip 46d is being pressed into a channel 44 past inwardly extending flanges 40 and to snap back outwards into a position engaging the flanges 40 and precluding extraction. The legs 90 are additionally constructed to be long enough to prevent the clip 46d from falling into the channel 44 or track without engaging the flanges 40.

The spring clip 46d also includes a resilient spring arm 52d that extends diagonally from the mounting base 54d of the spring clip 46d. When the spring clip 46d is installed properly, the spring arm 52d extends diagonally in a direction opposite the direction intended for window assembly frame 24, 26, 28, 30 insertion. The spring arm 52d is configured to bend outwardly toward the inner peripheral wall 19 of the window aperture 18 when contacting a leading or front edge of a window assembly frame that is being inserted into the window aperture 18. A plurality of the spring clips 46d are spaced around the inner peripheral wall 19 of the window aperture 18 so that their collective inward bias serves to center a window assembly that's being installed in the window aperture 18.

In addition to the various spring clip configurations disclosed above, the mass transit vehicle window installation assembly 10 may also include an elongated, circuitous trim strip ring 98 that approximates the outer planform shape of the window assembly frame 24, 26, 28 and the window aperture 18, 20. The trim strip ring 98 includes inner and outer elongated flanges 100, 102 shaped to engage respective back surfaces 104, 106 of the window assembly frame 24, 26, 28 and wall panel 22, respectively, and to cover a gap 108 formed between a peripheral outer wall of the window assembly frame 24, 26, 28 and an inner peripheral wall 19 of the window aperture 18, 20. The trim ring 98 has a generally T-shaped cross section formed by the inner and outer flanges 100, 102 as well as an elongated stem 110 that extends perpendicularly from the flanges 100, 102 and is shaped to be inserted into the gap 108. The stem 110 positively positions the trim ring 98 relative to the window assembly frame 24, 26, 28 and the window aperture 18, 20.

The trim strip ring 98 also includes a plurality of apertures (not shown) spaced around the length of its inner flange 100. The apertures receive fasteners (not shown) that extend through the inner flange 100 and into an existing groove 112 that runs around the back surface 104 of the window assembly frame 24, 26, 28. The fasteners hold the trim ring 98 against the respective back surfaces 104, 106 of the window assembly frame 24, 26, 28 and wall panel 22.

The trim strip ring 98 includes an elongated rubber seal ring shown at 116 in FIG. 3. The seal ring 116 is supported on the outer flange 102 of the trim ring 98. The seal ring 116 is positioned to be compressed between the outer flange 102 of the trim strip ring 98 and the back surface 106 of the wall panel 22. The seal ring 116 prevents moisture and drafts of air from passing through the wall panel 22 through the gap 108.

As shown in the Figures, window assembly frames 24, 26, 28 will often include front flanges 120 that extend outward from a main portion 122 of the frame in a position to be disposed against a front surface 124 of a wall panel 22 that the window assembly 12, 14, 16, 17 is installed in. The front flange 120 of a window assembly frame generally extends far enough to cover the gap 108 formed between the window assembly frame 24, 26, 28 and the inner peripheral wall 19 of a window aperture 18, 20 that the window assembly 12, 14, 16 is installed in. As shown in FIG. 3, an elongated rubber seal ring 122 is generally connected around and along a back surface of the front flange 120 of a window assembly frame in a position to seal against the front surface 124 of the wall panel 22.

In practice, a window assembly 12, 14, 16 can be installed and centered in a window aperture 18, 20 in a mass transit vehicle wall panel 22 by first providing a vehicle having a wall panel 22 that includes such a window aperture 18, 20 and a window assembly 12, 14, 16 that includes a window pane 15 supported around outer edges of the pane by a window assembly frame 24, 26, 28. A window assembly frame 24, 26, 28 is provided that has a general planform shape complementary to and smaller than that of the window aperture 18, 20. Window assembly retainers 32 configured to center the window assembly frame 24, 26, 28 in the window aperture 18, 20 are then attached either to the window assembly frame 24, 26, 28 or the window aperture 18, 20. The window assembly 12, 14, 16 is then inserted into the window aperture 18, 20 with the retainers 32 providing the desired spacing between the window assembly frame 24, 26, 28 and the window aperture 18, 20. The window assembly 12, 14, 16 is inserted into the window aperture 18, 20 after supporting the window assembly retainers 32 on either the window assembly frame 24, 26, 28, the window aperture 18, 20 or both, depending which embodiment of the retainer is employed.

Where, as shown in FIGS. 10-13, 17-21 and 22-26, a wall panel 22 includes a window aperture 18 that is defined by extruded structural channel having a recessed aperture detent 34 formed into an inner peripheral surface 19 of the window aperture 18, 20, window assembly retainers 32 that each include a spring clip 46 configured to engage the detent 34 are fixed at spaced locations around the window assembly frame 24, 26, 28. The window assembly 12, 14, 16 is then inserted into the window aperture 18, 20. During insertion, the window aperture 18, 20 forces the spring clips 46 to compress inward toward the window assembly frame 24, 26, 28 as shown in FIGS. 10-12, 17-19 and 22-24. The window assembly 12, 14, 16 is inserted until the spring clips 46 snap outward into engagement with the aperture detent 34 while remaining engaged against an inner peripheral surface 19 of the window aperture 18, 20 as shown in FIGS. 13, 20 and 25. In this engaged position the spring clips 46 block the window assembly 12, 14, 16 from moving in a direction opposite a direction of installation and also space the window assembly frame 24, 26, 28 a desired distance from an inner peripheral surface 19 of the window aperture 18, 20.

Where a wall panel 22 includes a window aperture 20 defined by a tubular structural member of generally rectangular cross-section, window assembly retainers constructed according to either the second or third embodiment of the invention are employed as shown at 32a and 32b in FIGS. 4 and 5, respectively. The spring clips 46a of the second embodiment have spring arms 52a intended to extend in the direction of insertion, the clips 46b of the second embodiment have spring arms 52b intended to extend opposite the direction of insertion.

When the spring clips 46a of the second embodiment are employed, they are supported on a window assembly frame in a position where their spring arms 52a extending in the direction of insertion. The frame bearing the clips 46a is then installed in a complementary window aperture 20, as shown in FIG. 4, where the spring arms 52a are in a position to hook over a back edge 76 of the window aperture 20 once the frame is fully inserted.

When the spring clips 46b of the third embodiment are employed, they are supported on a window assembly frame with their spring arms 52b extending opposite the direction of insertion. The frame bearing the clips 46b is then installed in a complementary window aperture 20, as shown in FIGS. 30-33, where the spring arms 52b are in a position to continuously bias respective distal ends 60b of the spring clips 46b outward against the inner peripheral surface 19 of the window aperture 20. In this installed position, the distal ends 60b of the spring clips 46b engage and provides an interference fit for the window assembly within the window aperture 20. The clips provide sufficient retention to hold the window assembly 12, 14, 16, 17 in place pending subsequent mechanical fastening of the window assembly 12, 14, 16, 17 into the window aperture 20.

Where, as shown in FIGS. 6 and 7, a wall panel 22 includes a window aperture 18 that's defined by extruded structural channel having a recessed aperture detent 34 formed into an inner peripheral surface 19 of the window aperture 18, 20, a retainer 32c constructed according to the fourth embodiment may be employed. According to the fourth embodiment, a window assembly 17 may be installed in such an aperture 18 by first attaching the spring clips 46c at spaced locations around the window assembly frame 30. This is done by first inserting the ears 78 of each clip 46c into a groove 80 formed around the outer peripheral wall of the window assembly frame 30 to be installed. By rotating each spring clip 46c approximately 90 degrees, the ears 78 of each clip 46c engage the respective opposing lateral undercuts 82 formed along opposite sidewalls of the groove 80. In other embodiments, the ears 78 may be inserted into a groove formed around the inner peripheral wall 19 of a window aperture 18 that the window assembly frame 30 is to be installed in rather than mounting the spring clips 46c around the outer peripheral wall of the window assembly frame 30.

Spring clips 46d constructed according to the fifth embodiment may also be used to install a window assembly in an aperture 18 defined by extruded structural channel as shown in FIGS. 8 and 9. The spring clips 46d are attached to such a window aperture 18 at spaced locations by inserting them, legs first, into the channel 44 until the legs 90 of each clip 46d engage the channel flanges 40. Once filly inserted, the legs 90 snap outward, i.e., away from each other, and engage the channel flanges 40 in such a way as to make extraction extremely difficult. Insertion, however, is quite easy due to the convergent, ramped configuration of the approximate outer halves of the legs 90. The convergent ramped portions of the legs 90 cause the legs 90 of each clip to squeeze together as each clip 46d is pushed into a window aperture channel 44.

When the window assembly 12, 14, 16, 17 is inserted in an aperture 18, 20 in a vehicle wall panel 22 the assembly may be inserted into the aperture either from a position outside the vehicle or from a position inside the vehicle. When the window assembly 12, 14, 16, 17 is inserted into an installed position from outside a vehicle it is inserted until the front flange 120 of the window assembly frame 24, 26, 28, or a sealing ring 122 supported on the flange 120, rests against a front surface 124 of the wall panel 22 on the exterior of the vehicle. A trim strip ring 98 may then be installed over the gap 108 formed between a back edge 76 of the window assembly frame 24, 26, 28 and a back edge 76 of the window aperture 18, 20 on an interior of the vehicle. The stem 110 of the trim strip ring 98 is inserted into the gap 108. The trim ring 98 may be secured by an interference or snap fit between the stem 110 and the gap 108 or by passing fasteners through apertures in the ring and into the groove 112 running around the back surface of the window assembly frame 24, 26, 28.

When the window assembly 12, 14, 16 is inserted into an installed position from inside a vehicle it is inserted until the front flange 120 of the window assembly frame 24, 26, 28, or a sealing ring 122 supported on the flange 120, rests against a back surface 106 of the wall panel 22 in the vehicle interior. The trim strip ring 98 is then installed over the gap 108 formed between a front edge 56 of the window assembly frame 24, 26, 28 and a back edge 76 of the window aperture 18, 20 on an exterior of the vehicle. The stem 110 of the trim strip ring 98 is inserted into the gap 108. The trim strip ring 98 may either be secured by an interference or snap fit between the stem 110 and the gap 108 or by passing fasteners through apertures in the trim strip ring 98 and into a groove formed around the front surface of the window assembly frame 24, 26, 28.

This description is intended to illustrate certain embodiments of the invention rather than to limit the invention. Therefore, it uses descriptive rather than limiting words. Obviously, it's possible to modify this invention from what the description teaches. One may practice the invention other than as described while remaining well within the scope of the claims.

What is claimed is:

1. A mass transit vehicle window installation assembly for simplifying and accelerating the installation of window assemblies in vehicle window apertures, the assembly comprising:
a retainer configured to connect between a window assembly frame and a vehicle wall panel having a window aperture shaped to receive the window assembly, where the window assembly frame [is configured to support a window assembly pane and] has a planform shape that generally complements that of the window aperture;
the retainer being additionally configured to space such a window assembly frame from an inner peripheral surface of a complementary window aperture; and
the retainer being additionally configured to be supported on one of a window frame and a complementary window aperture in a position to center the window assembly as the window assembly is inserted into the aperture.

2. A mass transit vehicle window installation assembly as defined in claim 1 in which the retainer is additionally configured to retain a window frame within a complementary window aperture.

3. A mass transit vehicle window installation assembly for simplifying and accelerating the installation of window assemblies in vehicle window apertures, the assembly comprising:
a plurality of window assembly retainers securable at spaced locations around and between a window frame and a window aperture;
each retainer of the plurality of retainers being configured to connect between a window assembly frame and a vehicle wall panel having a window aperture shaped to receive the window assembly, where the window assembly frame has a planform shape that generally complements that of the window aperture;
the plurality of retainers being additionally configured to space such a window frame from an inner peripheral surface of a complementary window aperture;
each retainer of the plurality of retainers being additionally configured to be supported on one of a window frame and a complementary window aperture in respective positions and to cooperatively center the window assembly as the window assembly is inserted into the aperture.

4. A mass transit vehicle window installation assembly as defined in claim 3 in which each retainer is additionally configured to retain the window frame within a complementary window aperture.

5. A mass transit vehicle window installation assembly as defined in claim 4 in which each retainer includes a spring clip configured to be fixed to a window frame and to snap outward into engagement with a recessed window aperture detent formed into an inside peripheral wall of a window aperture that is to receive the window frame.

6. A mass transit vehicle window installation assembly as defined in claim 3 in which at least one retainer of the plurality of retainers is configured to be fixed to an outer peripheral wall of the window frame.

7. A mass transit vehicle window installation assembly as defined in claim 6 in which:
at least one retainer includes a spring clip that includes an elongated resilient spring arm biased outwardly from a mounting base of the spring clip that attaches to the outer peripheral wall of the window frame; and
the spring arm is configured to bend inwardly when contacting a front edge of a window aperture that the window assembly is being inserted into and then to spring back outward when the window assembly is fully inserted and an outer distal end of the spring arm passes over a recess defining the aperture detent, the distal end of the spring arm engaging the aperture detent once the spring arm has sprung back outward.

8. A mass transit vehicle window installation assembly as defined in claim 7 in which the spring arm of at least one retainer comprises an elongated strip of spring steel.

9. A mass transit vehicle window installation assembly as defined in claim 7 in which the distal end of the spring arm of at least one retainer includes a centering surface configured to engage an inner peripheral surface of a window aperture [to space the window frame a predetermined desired distance from an inner peripheral surface of a window aperture that the window assembly is inserted into, and to prevent the spring arm from springing too far outward and causing the distal end of the spring arm to pass and miss engagement with an aperture detent formed in the inner peripheral wall of the window aperture].

10. A mass transit vehicle window installation assembly as defined in claim 9 in which:
at least one retainer includes a spring arm that extends from a mounting base of the retainer in a direction that, when the retainer is attached to an outer peripheral wall of a window frame, is generally opposite the direction of window assembly insertion; and
the distal end of the spring arm includes an S-bend forming a detent surface that abuts a recessed window aperture detent formed into an inside peripheral wall of a window aperture that is to receive the window frame; and
the distal end also includes an adjacent outer tab that includes the centering surface for engaging an inner peripheral surface of the receiving window aperture.

11. A mass transit vehicle window installation assembly as defined in claim 9 in which at least one retainer includes a spring arm that extends from a mounting base of the retainer in a direction that, when the retainer is attached to an outer peripheral wall of a window frame, is generally the same as the direction of window assembly insertion, and the distal end is configured to hook over a back edge of the receiving window aperture to secure the window assembly against extraction opposite the direction of window assembly insertion.

12. A mass transit vehicle window installation assembly as defined in claim 4 in which at least one retainer comprises a spring clip including:
a mounting base configured to support the retainer on a window assembly frame; and
a spring arm extending from the mounting base and configured to bend inward toward the mounting base when a window assembly frame that the retainer is supported on is inserted into a receiving window aperture and the spring arm engages a front edge of the aperture, the spring clip being further configured to continuously bias a distal end of the spring arm outward against an inner peripheral surface of the aperture, the distal end of the spring arm being configured to engage the inner peripheral surface of the aperture in such a way as to provide an interference fit for the window assembly within the receiving window aperture.

13. A mass transit vehicle window installation assembly as defined in claim 12 in which:
at least one retainer comprises a spring clip having a spring arm that, when the retainer is supported on a window frame, extends from a mounting base of the retainer in a direction generally opposite the direction of window assembly insertion; and
the distal end of the spring arm includes a saw tooth edge configured to dig into an inner peripheral surface of the receiving window aperture to a depth sufficient to secure the window assembly against extraction from the window aperture opposite the direction of window assembly insertion.

14. A mass transit vehicle window installation assembly as defined in either claim 1 or 3 in which:
the retainer includes a trim strip ring that approximates the outer planform shape of a window aperture and a complementary window assembly frame configured to be installed in that window aperture;
the trim strip ring is configured to engage respective back surfaces of the window assembly frame and a wall panel that the aperture is formed in and to cover a gap formed between a peripheral outer surface of the window frame and a peripheral inner surface of the window aperture when the window frame is installed in a window aperture in the wall panel.

15. A mass transit vehicle window installation assembly as defined in claim 14 in which the trim strip ring includes an elongated stem configured to be inserted in a gap formed between a peripheral outer surface of a window assembly frame and peripheral inner surface of a window aperture receiving the window assembly frame.

16. A mass transit vehicle window installation assembly as defined in claim 14 in which the trim strip ring includes an elongated seal ring configured to prevent moisture and drafts of air from passing through a gap formed between a peripheral outer surface of a window assembly frame and peripheral inner surface of a window aperture receiving the window assembly frame.

17. A mass transit vehicle window installation assembly as defined in either claim 1 or claim 3 in which:
the vehicle window installation assembly includes a window assembly frame having a front flange that extends outward from a main portion of the frame in a position disposed against a front surface of a wall panel that the window assembly is installed in;
the front flange covers the gap between the window frame and the inner peripheral wall of a window aperture that the window assembly is installed in; and
an elongated rubber seal ring is connected around and along a back surface of the front flange in a position to seal against the front surface of the wall panel.

18. A mass transit vehicle window installation assembly as defined in claim 7 in which the mounting base of the spring clip of at least one of the retainers includes a pair of radially extending diametrically opposed attachment ears configured to engage respective opposing lateral undercuts formed along opposite sidewalls of a groove formed around and outer peripheral wall of a window frame.

19. A mass transit vehicle window installation assembly as defined in claim 4 in which at least one of the retainers includes a spring clip configured to be supported on the window aperture and to engage a window assembly frame when the window assembly frame is inserted into a complementary window aperture.

20. A mass transit vehicle window installation assembly as defined in claim 4 in which at least one retainer of the plurality of retainers includes a spring clip configured to engage opposing channel side walls of a channel formed into and around an inner peripheral wall of a receiving window aperture.

21. A mass transit vehicle window installation assembly as defined in claim 20 in which the spring clip of at least one retainer includes a pair of legs that extend from a base element of the clip and are shaped to engage a pair of elongated flanges that extend inwardly from opposing channel sidewalls of a channel formed into and around an inner peripheral wall of the window aperture.

22. A mass transit vehicle window installation assembly as defined in claim 21 in which the legs of the spring clip of the at least one retainer have S-shaped bends configured to allow the legs to bend inward as the they are being pressed into a channel past flanges that extend inwardly from opposing channel sidewalls and then to snap back outwards into a position engaging the flanges and precluding extraction.

23. A mass transit vehicle window installation assembly as defined in claim 21 in which the legs of the spring clip of the at least one retainer are long enough to prevent the clip from falling into the channel or track without engaging the flanges.

24. A mass transit vehicle window installation assembly as defined in claim 21 in which:
the clip includes a resilient spring arm that extends diagonally from the base element of the clip in a direction generally opposite the direction intended for insertion of a window assembly frame;
the spring arm is configured to bend outwardly toward the inner peripheral wall of a window aperture that the clip is installed in when contacting a front edge of a window assembly frame that is being inserted into the window aperture.

25. A mass transit vehicle window installation assembly as defined in claim 24 in which a plurality of the spring clips are spaced around the inner peripheral wall of the window aperture so that a collective inward bias of the spring arms of the spring clips centers the window assembly in the window aperture upon insertion.

26. A method for centering and retaining a window assembly in a window aperture formed in a mass transit vehicle wall panel, the method including the steps of:
providing a vehicle wall panel including a window aperture;
providing a window assembly including a window assembly pane supported around outer edges of the pane by a window assembly frame, the window assembly frame having a general planform shape complementary to and smaller than that of the window aperture;
supporting a window assembly retainer on one of the window assembly frame and the window aperture; and
inserting the window assembly into the window aperture after supporting the window assembly retainer on one of the window assembly frame and the window aperture.

27. The method of claim 26 in which the step of providing a vehicle wall panel includes providing a window aperture in the wall panel, the aperture being at least partially defined by extruded structural channel having a recessed detent formed into an inner peripheral surface of the window aperture.

28. The method of claim 26 in which:
the step of supporting a window assembly retainer includes providing a window assembly retainer that includes a spring clip fixed to the window frame; and
the step of inserting the window assembly includes:
inserting the window assembly such that the spring clip is compressed inward toward the window frame; and
inserting the window assembly until the spring clip snaps outward into engagement with the aperture detent while remaining engaged against an inner peripheral surface of the window aperture to both block the window assembly movement in a direction opposite a direction of installation and to space the window frame a desired distance from the inner peripheral surface of the window aperture.

29. The method of claim 28 in which:
the step of providing a wall panel includes providing a window aperture in the wall panel, the aperture being at least partially defined by a tubular structural member;
the step of supporting a window assembly retainer includes:
providing a window assembly retainer that includes a spring clip;
supporting the spring clip on the window frame; and
the step of inserting the window assembly includes inserting the window assembly such that the spring clip bends inward upon engagement with an outer edge of the window aperture as the window assembly is inserted into the window aperture and the spring clip continuously biases a distal end of the spring clip outward against the inner peripheral surface of the window aperture such that the distal end of the spring clip engages and provides an interference fit for the window assembly within the window aperture.

30. The method of claim 26 in which the step of supporting a window assembly retainer on one of the window frame and the window aperture includes supporting a plurality of window assembly retainers at spaced locations around one of the window frame and the window aperture.

31. The method of claim 26 in which the step of supporting a window assembly retainer on one of the window frame and the window aperture includes:
providing a retainer that includes a spring clip comprising a pair of diametrically opposed attachment ears;
inserting the ears into a groove formed around one of the outer peripheral wall of the window frame and the inner peripheral wall of the window aperture; and
engaging the ears in respective opposing lateral undercuts formed along opposite sidewalls of the groove by rotating the spring clip.

32. The method of claim 26 in which:
the step of providing a retainer includes providing a spring clip comprising a pair of legs shaped to engage and retain the clip between opposing flanges that extend inwardly from side walls of a channel formed into and around the inner peripheral wall of the window aperture, and
the step of supporting a window assembly retainer includes inserting the legs into a channel formed around the inner peripheral wall of the window aperture until the legs engage the flanges.

33. The method of claim 26 in which the step of inserting the window assembly includes inserting the window assembly from a position outside a vehicle including the wall panel such that a front flange of the window frame rests against a front surface of the wall panel on the exterior of the vehicle with the window assembly in an installed position.

34. The method of claim 26 further including the step of installing a trim ring over a gap formed between a back edge of the window frame and a back edge of the window aperture on an interior of the vehicle.

35. The method of claim 34 in which the step of installing a trim ring includes snapping the trim ring into place.

36. The method of claim 26 in which the step of inserting the window assembly into the window aperture includes inserting the window assembly from a position inside a vehicle including the wall panel such that a front flange of the window frame rests against a back surface of the wall panel in the vehicle interior with the window assembly in an installed position.

37. The method of claim 26 further including the step of installing a trim ring over a gap formed between a front edge of the window frame and a back edge of the window aperture on an exterior of the vehicle.

38. The method of claim 37 in which the step of installing the trim ring includes snapping it into place.

39. The method of claim 37 in which the step of installing the trim ring includes passing fasteners through the trim strip ring and into an existing groove that runs around the back surface of the window frame.
